(19) United States
(12) Patent Application Publication
(10) Pub. No.: US 2002/0163426 A1
(43) Pub. Date: Nov. 7, 2002

(54) System and method for detection and notification of unauthorized, animate beings in a vehicle

(75) Inventor: Paul Andrew Moskowitz, Yorktown Heights, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY

(21) Appl. No.: 09/847,327

(22) Filed: May 3, 2001

(51) Int. Cl. B60R 25/10; G08B 23/00

(52) U.S. Cl. 340/426; 340/573.1; 340/573.3; 340/573.4; 340/572.1; 340/988

(57) ABSTRACT

A system (and method) includes at least one sensor for sensing, in a vehicle, a presence of an unauthorized being, at least one system for emitting a warning based upon the output of the at least one sensor, and a device for transmitting a signal from the at least one sensor to the warning device.

### BACKGROUND OF THE INVENTION

1. Field of the Invention

The present invention generally relates to a vehicle, and more particularly to a vehicle including a system for detecting the presence of unauthorized animate beings (e.g., children, wild animals, pets, etc.) in the vehicle, and to providing a system for warning the inhabitants of the vehicle and others of the situation.

2. Description of the Related Art

Vehicles, particularly parked automobiles, can be infiltrated by wild animals (e.g., non-pet animals) or pets who enter the wheel wells, passenger compartment, engine compartment, or trunk of the vehicle. Such animals may cause damage to the vehicle or be harmed when the vehicle is started or put in motion. Unfortunately, such occurrences are too common (e.g., see “The Mouse That Rode, Pests Can Invade Cars and Inflict Serious Damage”, Los Angeles Times (Home Edition), Wednesday, Feb. 14, 2001, Page G-1). Wild animals, such as rodents, will enter vehicles when cold weather sends them searching for warm, dry nesting spots. They may eat through insulation, thereby damaging electrical wiring. The owner of the vehicle often does not realize that a rodent (e.g., rat or squirrel), has caused damage until a vehicle system fails.

Another serious situation occurs when a pet (e.g., dog, cat, rabbit, etc.) seeks shelter in the vehicle. Often, they are killed or injured when the vehicle is set in motion. In addition, children may become locked in the trunk of the vehicle. While pets or children may be transported within a vehicle, for purposes of the present invention, when they enter a vehicle space without the knowledge or authorization of the owner, they are considered “unauthorized beings.” In such a situation, they then may do harm to the vehicle or be harmed by the vehicle.

Although the above-described phenomena is widespread, hitherto the present invention, there has been no recognition that this is a technical problem that may have a technical solution. Automobiles have been manufactured with systems to warn of open doors, keys in the ignition, lights being left on, etc. Further, sensors have been manufactured to detect the presence of humans or animals.

However, notwithstanding all of the above, it is assumed that it is the vehicle owner's fault or, at best, an unfortunate accident if a pet (or child) enters a vehicle without the owner's knowledge and is subsequently harmed. It is also assumed that owners will keep unauthorized animals or children from infiltrating the vehicle by parking the vehicle in a locked garage or other sealed area. Also, there is no warning system to indicate that a wild animal is present and is possibly damaging the vehicle's electrical system.

Computer technology for providing information and application functions to automotive vehicles is becoming pervasive. For example, vehicles are being outfitted with computers that control communication devices (e.g., cellular phones, navigation systems, etc.) sensors, display and warning devices.

These computerized devices are useful for controlling a vehicle or for the entertainment of the vehicle's unauthorized beings (e.g., see U.S. patent application Ser. No. 09/311,277 entitled “Information System for Mobile Users”, filed on May 14, 1999, and U.S. patent application Ser. No. 09/357,840, entitled “System and Method for Network Vehicle Diagnostics and Health Monitoring” filed on Jul. 20, 1999, both incorporated herein by reference).

Computer technology has been used to control user interface devices such as fax machines, touch screens, speech synthesis and text-to-speech systems, and wireless control device interfaces. Computer technology also has been used to detect the presence of drivers and passengers, including animals, and to adjust the user interface systems of the vehicle (See U.S. Pat. No. 6,181,996, issued Jan. 30, 2001 to Chou et al., incorporated herein by reference).

Such technology has also been used to sense and warn of objects left inadvertently on the surfaces of a vehicle (See U.S. Pat. No. 6,163,250 issued Dec. 19, 2000 to Moskowitz, incorporated herein by reference).

Such technology has also been used to detect dangerous situations in a vehicle, detect the presence of a human or an animal and warn the occupants of the vehicle or others by means of user interface or communication devices. (See U.S. patent application Ser. No. ______ , filed Apr. 6, 2001, entitled “System for Detection and Notification of Dangerous Environmental Situations in a Vehicle”, having Assignee's Docket No. YOR9-2000-0273, by Moskowitz and Pickover, incorporated herein by reference).

The problem of identifying the presence of humans, including animals, in a motor vehicle and the importance of controlling vehicle safety systems has been recognized previously. Identifying beings in a vehicle is accomplished using a variety of mechanisms. For example, force sensors, ultrasonic detectors, capacitance detectors, optical detectors, and sound detectors have been used. Beings are detected in order to enable or advise the use of safety devices such as seat belts, air bags, etc.

However, while the above-described equipment is widespread, there has been no recognition that such computer systems may be used to sense the presence and nature (i.e., child, pet, or wild animal) of an unauthorized animate being, and to sense that such a being has entered the vehicle without the knowledge of the owner, and is somewhere within the vehicle, and to provide a warning.

### SUMMARY OF THE INVENTION

In view of the foregoing and other problems, drawbacks, and disadvantages of the conventional methods and structures, the present invention has been devised.

An object of the present invention is to provide a method and structure for detecting the presence of unauthorized animate beings within the various spaces of a vehicle.

It is another object of the invention to detect when an unauthorized infant, child, wild animal, or pet, is in the vehicle so that others may be properly warned of the dangerous situation.

Additionally, it is an object of the invention to control a device to provide a warning to occupants and others that there is an unauthorized animate being present somewhere in the vehicle.

Yet another object of the invention to provide a warning to others than the vehicle occupants by controlling a communications device to provide notice of the dangerous situation to authorities at a remote location.

In a first aspect of the invention, a system for detecting and warning of an unauthorized animate being includes at least one sensor for sensing the presence of an unauthorized animate being in a vehicle, and a controller for controlling a warning device based upon an output signal from the at least one sensor.

Thus, with the unique and unobvious aspects of the invention, the presence of unauthorized beings within the vehicle can be detected. Further, it can be detected when an unauthorized animate being is a child, wild animal or pet, so that others may be properly warned of the dangerous situation.

Further, with the invention, a device can be controlled to provide a warning to vehicle occupants and others that there exists an unauthorized animate being within the vehicle, and a warning can be provided to person(s) other than the vehicle occupants by controlling a communications device to provide notice of the situation to others at a remote location.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is a schematic diagram of a vehicle 110 including an animate being (e.g., wild animal, child, pet, etc.) and a device for detecting the presence of such an animate being according to a preferred embodiment of a system 100 of the present invention;

FIG. 2 is a system diagram of components according to the present invention;

FIG. 3 illustrates an exemplary hardware/information handling system 300 for incorporating the present invention therein; and

FIG. 4 illustrates a signal bearing medium (e.g., storage medium) 400 for storing steps of a program for detection and notification of dangerous environmental situations/conditions in a vehicle according to the present invention.

### DETAILED DESCRIPTION OF PREFERRED EMBODIMENTS OF THE INVENTION

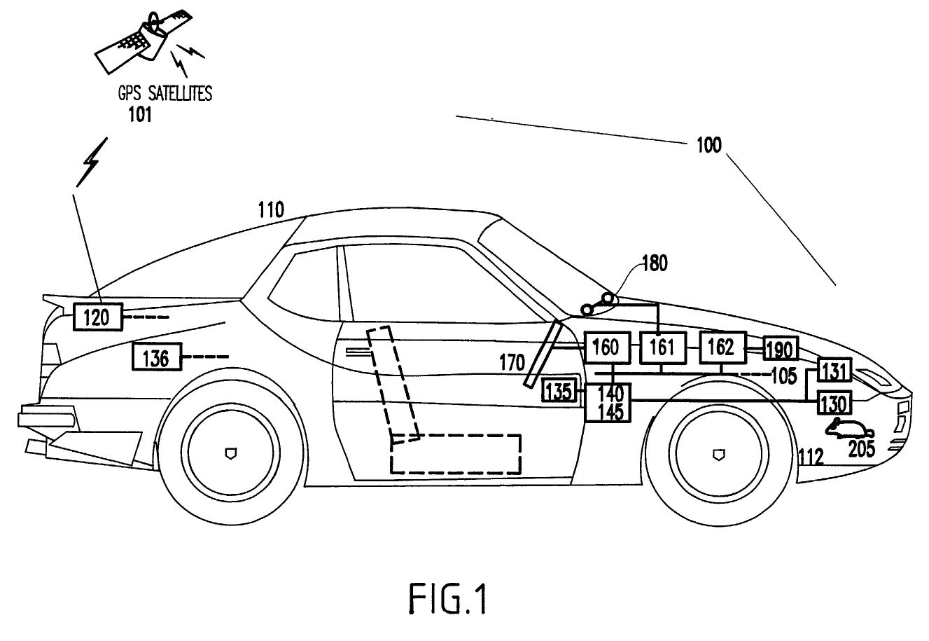

Referring now to the drawings, and more particularly to FIGS. 1-4, there are shown preferred embodiments of the method and structures according to the present invention.

### PREFERRED EMBODIMENT

Referring to FIG. 1, a vehicle system 100 is shown for use with a vehicle 110 and includes an animate being 205 (e.g., a wild animal, a pet, a child, or an infant) within the wheel well 112 of the vehicle 110. In this diagram, the unauthorized animate being shown is a rat. The being could equally be a child or infant, a pet (e.g., dog, cat, etc., or any of a variety of wild non-pet animals, e.g. rat, mouse, squirrel, skunk, possum, woodchuck, raccoon, bird, etc.).

The animate being could equally be located in the engine compartment, the passenger compartment, the trunk, under the chassis, in the bumper, as well as in the wheel well of the vehicle.

The system 100 includes at least one sensor (e.g., sensor circuit) and more preferably a plurality of sensors 130, 131, 135, 136 located at different positions in the vehicle 110, an electronic control unit (ECU) 140 (and more preferably a plurality of ECUs 140, 145) for controlling the sensor circuits, a vehicle communication bus 105 for carrying data and control signals, an ECU 160 interfaced with the bus 105, and at least one interface device (and more preferably a plurality of interface devices) including, for example, any one or more of a visual display 170, an audio system 180 and the like.

Further, additional devices 190 may be provided, including a telecommunications device which may be a cell phone or a digital communications device such as a digital device that uses a cell phone network, or a Bluetooth device. Bluetooth is a specification for a high-frequency, high-data radio communications system. The complete Bluetooth specification may be found at www.bluetooth.com on the World Wide Web (WWW).

A location detector 120 may also be installed to provide information on the vehicle's location to the car bus 105 when used with a system of Global Positioning Satellites (GPS) 101 system. Although the vehicle shown in the diagram is an automobile, other vehicles for which the system may be applied include trucks, buses, boats, mobile homes, elevators, etc.

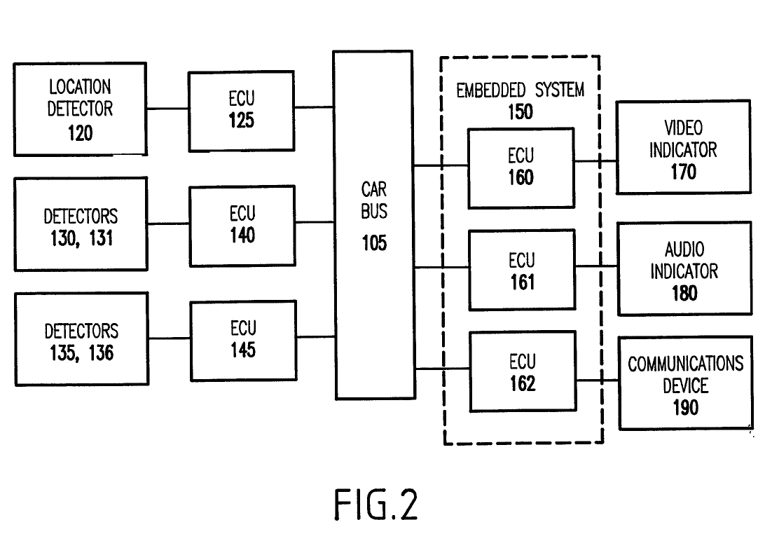

Referring to FIG. 2, a block diagram of the system 100 according to the present invention is shown and is described below.

The system 100 includes a sensor 130 for detecting an unauthorized being (e.g., 205 shown in FIG. 1) located inside of the vehicle 110. Sensor 130 is placed in the wheel well, sensor 131 is placed in the engine compartment, sensor 135 is placed in the passenger compartment, and sensor 136 is placed in the trunk The sensors can be formed of known and commercially available components. Many types of sensors may be employed including any one or more of infrared sensors, capacitive sensors, force/pressure sensors, microphones or sound detectors etc., and are well-known in the art. Such sensor components and configurations are described in, for example, U.S. Pat. No. 4,300,116, U.S. Pat. No. 5,402,075, U.S. Pat. No. 5,313,189, U.S. Pat. No. 5,629,488, U.S. Pat. No. 5,871,063, U.S. Pat. No. 5,297,430, U.S. Pat. No. 5,305,644, U.S. Pat. No. 5,857,536, U.S. Pat. No. 5,654,615, U.S. Pat. No. Reissue 034,773, and U.S. Pat. No. 5,602,526, each incorporated herein by reference. Moreover, U.S. Pat. No. 5,404,128, also incorporated herein by reference, describes the detection of an unauthorized being based upon the life activity of the human body including heart beat. Such a system using the distinguishing characteristics of a heart beat (e.g., rate, shape, QRS complex, etc.) may be used to distinguish humans from non-humans.

The system also includes a location detector 120 which provides information in digital form to an ECU 125. The ECUs 125, 140, and 145 are coupled to a car bus 105.

The presence of an unauthorized being causes a change in the electrical characteristics of the sensor 131. The sensor's electrical characteristics are monitored by ECU 140, which responds to a change by reporting a detection code over the car bus, such as a Society of Automotive Engineers (SAE) J1850 communication bus, or a Controller Area Network (CAN). The other sensors similarly may report a detection code representing the parameters detected to the car bus 105. The car bus 105 in turn provides the code to a second set of ECUs 160, 161, 162 which control devices 170, 180, 190.

The ECUs 160, 161, 162 and additional ECUs, as necessary, may be provided as components within an embedded electronic or computing system 150 within the vehicle. The interface may control visual and/or audio systems 170, 180, and a communication system 190.

Additionally, if a dangerous situation is detected (e.g., a wild animal is detected by detector 131 in the engine compartment, or a child is detected by detector 136 in the trunk), the communications system may be instructed to send a warning or call for help (e.g., a call to a service center or a 911 call to police).

The audio indicator 180 may be a warning device, such as a buzzer or a speech synthesis interface, or a text-to-speech interface, inside the vehicle or one that may be observed outside the vehicle (e.g., a car horn honking, etc.). The visual indicator 170 may be a warning device, such as an indicator light or a display screen, inside the vehicle or one that may be observed outside the vehicle (e.g., car headlights flashing, etc.).

Similar sensors and ECUs may be used to detect whether the vehicle is in motion or not, or whether the engine is on or off. Such information may be analyzed by an embedded computing system 150 according to an algorithm stored in that system.

The embedded system 150 may initiate a call for help through the use of a communications device 190 (e.g., a cell phone or a Bluetooth communications device). The information provided by the communications device within the call for help may include vehicle identification number (VIN), manufacturer, model and color of the vehicle, location of the vehicle, parameters characterizing the dangerous situation, and information on the unauthorized being in the vehicle (e.g., infant, child, pet, or other animal, etc.).

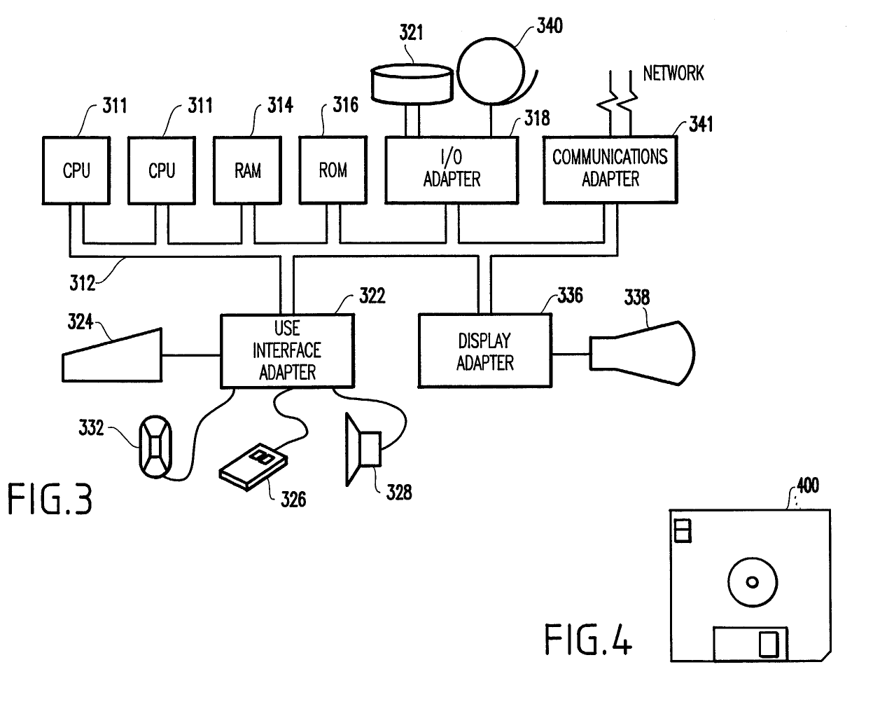

FIG. 3 illustrates a typical hardware configuration of an information handling/computer system which can be used with the invention and which preferably has at least one processor or central processing unit (CPU) 311.

The CPUs 311 are interconnected via a system bus 312 to a random access memory (RAM) 314, read-only memory (ROM) 316, input/output (I/O) adapter 318 (for connecting peripheral devices such as disk units 321 and tape drives 340 to the bus 312), user interface adapter 322 (for connecting a keyboard 324, mouse 326, speaker 328, microphone 332, and/or other user interface device to the bus 312), a communication adapter 334 for connecting an information handling system to a data processing network, the Internet, an intranet, a personal area network (PAN), etc., and a display adapter 336 for connecting the bus 312 to a display device 338 and/or printer 339.

Thus, as shown in FIG. 4 in addition to the hardware and process environment described above, a different aspect of the invention includes a computer-implemented method according to the present invention, as described above. As an example, this method may be implemented in the particular hardware environment discussed above.

Such a method may be implemented, for example, by operating the CPU 311 (FIG. 3), to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 311 and hardware above, to perform the method of the invention.

This signal-bearing media may include, for example, a RAM contained within the CPU 311, as represented by the fast-access storage for example. Alternatively, the instructions may be contained in another signal-bearing media, such as a magnetic data storage diskette 400 (FIG. 4), directly or indirectly accessible by the CPU 311.

Whether contained in the diskette 400, the computer/CPU 311, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

Thus, as described above, the present invention provides a system in which the presence of unauthorized beings and the existence of a dangerous or life threatening condition can be detected. Further, it can be detected when an unauthorized being is a non-adult human (child or infant) or an animal or pet, so that others may be properly warned of the dangerous situation.

Additionally, the inventive device can be controlled to provide a warning that there exists a dangerous or life-threatening situation, and a warning can be provided to person(s) other than the vehicle occupants by controlling a warning device that may be observed by a person who is external to the vehicle. Moreover, the warning can be provided to persons other than the vehicle occupants by controlling a communications device to provide notice of the dangerous situation to authorities at a remote location.

When the system described above is installed in vehicles, damage to the vehicle will be reduced and lives may be saved. As a result, given the rise in personal safety and the reduction in damage (and thus reduction of claims), it will be advantageous for insurance companies to give users of the system incentives for the installation of the system. It may also be advantageous for the government to give manufacturers of the system incentives for the incorporation of the system in vehicles.

While the invention has been described in terms of several preferred embodiments, those skilled in the art will recognize that the invention can be practiced with modification within the spirit and scope of the appended claims.

What is claimed is:

1. A system, comprising:
at least one sensor for sensing, in a vehicle space, a presence of an unauthorized being;
at least one system for emitting a warning based upon the output of said at least one sensor; and
a device for transmitting a signal from said at least one sensor to said warning device.

2. The system of claim 1, wherein the unauthorized being includes at least one of a child, a pet, and a non-pet animal.

3. The system of claim 1, wherein said vehicle comprises one of an automobile, a truck, a bus, a boat, a mobile home, and an elevator.

4. The system of claim 1, wherein said vehicle space comprises one of a wheel well, an engine compartment, a bumper, a trunk, and a passenger compartment.

5. The system of claim 1, wherein said at least one system for emitting a warning comprises a visual warning indicator.

6. The system of claim 5, wherein said visual warning indicator comprises at least one of an indicator light, a display screen, and a flashing headlight of said vehicle.

7. The system of claim 1, wherein said at least one system for emitting a warning comprises an audio warning indicator.

8. The system of claim 7, wherein said audio warning indicator comprises at least one of a buzzer, a text-to speech interface, a speech synthesis interface internal to said vehicle and a car horn honking external to said vehicle.

9. The system of claim 1, wherein said at least one system for emitting a warning comprises a communications device.

10. The system of claim 9, wherein the communications device comprises at least one of a cellular phone and a Bluetooth communications device.

11. The system of claim 9, wherein the communications device transmits information containing at least one of a vehicle identification number (VIN) of the vehicle, a manufacturer of the vehicle, a model of the vehicle, a color of the vehicle, a location of the vehicle, and information regarding the unauthorized being in the vehicle.

12. The system of claim 11, wherein said information regarding the unauthorized being of the vehicle comprises information regarding whether said unauthorized being is a child, an infant, a pet, or non-pet animal.

13. The system of claim 1, wherein the vehicle comprises one of a stationary vehicle and a vehicle in motion.

14. The system of claim 12, wherein the pet is one of a cat and a dog.

15. The system of claim 1, further comprising:
an incentive-providing system for providing an incentive for the installation of the system.

16. The system of claim 1, further comprising:
an incentive-providing system for providing an incentive for the use of the system.

17. The system of claim 1, wherein said at least one sensor comprises a sensor for sensing a presence of said unauthorized being.

18. The system according to claim 1, wherein a plurality of ones of said at least one sensor are provided at predetermined positions in said vehicle.

19. The system according to claim 1, wherein said device comprises an electronic control unit (ECU) for processing said output signal from said at least one sensor.

20. The system according to claim 19, wherein said device further comprises a vehicle communication bus for carrying data to said electronic control unit.

21. The system according to claim 20, wherein said device comprises a plurality of electronic control circuits connected to said vehicle communication bus.

22. The system according to claim 21, wherein said plurality of electronic control circuits connected to said vehicle communication bus are selectively interfaced with a plurality of devices.

23. The system according to claim 12, wherein the non-pet animal is one of a rat, mouse, squirrel, skunk, possum, woodchuck, raccoon, and a bird.

24. The system according to claim 20, wherein said bus comprises one of a Society of Automotive Engineers (SAE) J1850 bus and a Controller Area Network bus.

25. The system according to claim 22, wherein said plurality of devices comprise at least one of a visual display device, an audio system, a telecommunications device, a speech synthesis interface, and a text-to-speech interface.

26. The system according to claim 1, wherein said at least sensor includes a sensor for sensing a heartbeat of said unauthorized being in said vehicle.

27. The system according to claim 26, wherein said sensor senses a heartbeat pattern of said unauthorized being and whether said heartbeat pattern includes a predetermined shape.

28. A system for detecting and warning of a presence of an unauthorized animate being in a vehicle, comprising:
at least one sensor for sensing a presence of an unauthorized being in a vehicle; and
a controller for controlling a warning device based upon an output signal from the at least one sensor.

29. A method, comprising:
sensing, in a vehicle, a presence of an unauthorized being;
emitting a warning, by a warning device, based upon the sensing of said presence; and
transmitting a signal to said warning device.

30. A signal-bearing medium tangibly embodying a program of machine-readable instructions executable by a digital processing apparatus to perform a method for computer-implemented detection and notification of unauthorized, animate beings in a vehicle, said method comprising:
sensing, in a vehicle, a presence of an unauthorized being;
emitting a warning, by a warning device, based upon the sensing of said presence; and
transmitting a signal to said warning device.
